(19) United States
(12) Patent Application Publication
(10) Pub. No.: US 2024/0313278 A1
(43) Pub. Date: Sep. 19, 2024

(54) Method for Operating an Electrical Stored Energy Source, and Electrical Stored Energy Source

(71) Applicant: BAYERISCHE MOTOREN WERKE AKTIENGESELLSCHAFT, München (DE)

(72) Inventors: Philip RAETTICH, Stoettwang (DE); Sebastian SCHARNER, Tuerkenfeld (DE)

(21) Appl. No.: 18/275,430

(22) PCT Filed: Jan. 25, 2022
(86) PCT No.: PCT/EP2022/051555

§ 371 Date: Aug. 2, 2023

(30) Foreign Application Priority Data
Feb. 11, 2021 (DE) 10 2021 103 207.5

(51) Int. Cl. H01M 10/48; H01M 50/204; H01M 50/342

(52) U.S. Cl. CPC H01M 10/48; H01M 50/204; H01M 50/3425; H01M 2200/20; H01M 2220/20

(57) ABSTRACT

A method for operating an electrical stored energy source having a housing and at least one storage cell which is situated inside the housing. The method includes: first, a malfunction of the at least one storage cell and/or of the electrical stored energy source is determined, in which malfunction a fuel gas-air mixture is formed inside the housing. Then, inert gas is metered into the housing by a metering device of the electrical stored energy source, wherein sufficient inert gas is metered into the housing that the oxygen concentration inside the housing assumes a threshold value. The oxygen concentration is detected by an oxygen sensor of the electrical stored energy source. The threshold value is less than or equal to the oxygen limit concentration, which is defined as the maximum oxygen concentration at which combustion of the mixture of fuel gas, air and inert gas in the electrical stored energy source is not possible.

### BACKGROUND AND SUMMARY

The invention relates to a method for operating an electrical stored energy source and an electrical stored energy source.

An electrical stored energy source is a stored energy source on an electrochemical basis, which is rechargeable and is adapted to store electrical energy and provide it to consumers, in particular consumers in a vehicle.

Electrical stored energy sources can include a plurality of storage cells connected in parallel and/or in series, wherein the storage cells are arranged in a common housing of the electrical stored energy source.

If a malfunction of at least one of the storage cells occurs, a so-called “thermal event” (also designated as “thermal runaway”) can occur, in which combustible gases can escape from the faulty storage cell into the housing of the electrical stored energy source. To prevent explosive gas mixtures from forming within the housing, flooding the housing with an inert gas upon the occurrence of a malfunction or a thermal event is known. However, this has the disadvantage that large amounts of inert gas have to be kept ready and/or generated in an extremely short time, because of which such systems have to be overdesigned. This results in increased weight, increased space requirement, and/or increased costs of the electrical stored energy source.

The object of the invention is to provide a possibility for cost-effectively operating an electrical stored energy source and an electrical stored energy source which can be operated accordingly. In particular, the amount of inert gas to be stored to operate the electrical stored energy source is to be reduced.

The object of the invention is achieved by a method for operating an electrical stored energy source, wherein the electrical stored energy source comprises a housing and at least one storage cell arranged inside the housing, and wherein the method comprises the following steps: firstly, a malfunction of the at least one storage cell and/or the electrical stored energy source is established, in which a combustible gas-air mixture is formed within the housing. Inert gas is thereupon metered into the housing by way of a metering device of the electrical stored energy source, wherein enough inert gas is metered into the housing that the oxygen concentration within the housing assumes a threshold value. The oxygen concentration is ascertained by use of an oxygen sensor of the electrical stored energy source. The threshold value is equal to or less than the limiting oxygen concentration, which is defined as the maximum oxygen concentration at which no combustion of the mixture of combustible gas, air, and inert gas in the electrical stored energy source is possible.

It has been recognized that the limiting oxygen concentration (also known under the abbreviation LOC) is particularly suitable as a threshold value, on the basis of which the amount of inert gas to be supplied can be established. If the threshold value is maintained, according to the invention, reliable operation of the electrical stored energy source can be ensured and also the amount of inert gas required for this purpose can be reduced.

This results in particular in a lower demand for inert gas in comparison to electrical stored energy sources which are completely flooded with inert gas in the event of a malfunction, so that the total weight and the space requirement of the electrical stored energy source may be reduced and the costs both for the production and the operation of the electrical stored energy source can be reduced.

The oxygen concentration within the housing indicates the content of oxygen in the gas composition within the empty volume of the housing. In other words, the oxygen concentration relates to the volume within the housing of the electrical stored energy source in which only gaseous components are located.

The limiting oxygen concentration can be determined before operating the electrical stored energy source, since it is only dependent on the combustible gas to be expected in the event of a malfunction of the at least one storage cell and/or the electrical stored energy source, the inert gas used, and the known composition of air.

The limiting oxygen concentration can be defined according to EN 1839.

The combustible gas comprises in particular decomposition products of components used in the at least one storage cell, for example decomposition products of an electrolyte, of active materials, and/or of additives.

The inert gas is selected in particular from the group consisting of gaseous extinguishing agents, noble gases, and combinations thereof, preferably from the group consisting of carbon dioxide, nitrogen, argon, and combinations thereof. The inert gas is particularly preferably carbon dioxide.

“Gaseous extinguishing agents” are here and hereinafter gaseous compounds which can be used in terms of an inert gas but are not noble gases. In other words, gaseous extinguishing agents within the meaning of the present application do not undergo chemical reactions upon flooding of the housing.

Suitable gaseous solvents are, for example, carbon dioxide, nitrogen, and fluoroketones. One example of a suitable fluoroketone is available under the designation “Novec 1230” from the 3M Corporation.

In principle, inert gases are preferred which may be liquefied at room temperature and a pressure of 10 bar or less. Liquefied gases may be handled more easily and enable a particularly space-saving storage.

For example, “Novec 1230” can be liquefied at a temperature of 25° C. at a pressure of 4 bar.

The oxygen concentration is ascertained by the oxygen sensor in particular via the oxygen partial pressure within the housing of the electrical stored energy source. Oxygen sensors for measuring the oxygen partial pressure are available inexpensively and only require little installation space within the housing of the electrical stored energy source.

The oxygen sensor and the metering device are in particular connected for data exchange. In this way, the proportion of inert gas in the housing of the electrical stored energy source can be regulated in a simple manner based on the measurement data of the oxygen sensor. In particular, the oxygen sensor can send an electrical regulating signal to the metering device.

The metering device in particular has a valve, via which the amount of inert gas supplied to the housing can be controlled.

The at least one storage cell is in particular a lithium-ion cell and the electrical stored energy source is in particular a secondary lithium-ion battery.

In particular, the electrical stored energy source is a traction battery for use in a vehicle. In vehicles, the installation space available for storing inert gas is particularly limited. At the same time, traction batteries typically have a particularly high energy density, which makes necessary appropriate measures for reliable operation. The minimization of the amount of inert gas required in the method according to the invention is therefore particularly advantageous for the reliable operation of a traction battery.

In one variant, the electrical stored energy source includes multiple oxygen sensors. In this way, the oxygen concentration within the housing can be ascertained in a spatially resolved manner, by which locating of a faulty storage cell by the oxygen sensors is enabled.

Furthermore, a redundancy for ascertaining the oxygen concentration is created, so that the data ascertained by the oxygen sensors can be compared and/or averaged and even more reliable operation of the electrical stored energy source can be enabled.

Moreover, in this variant the oxygen concentration can still be ascertained even in the event of failure of at least one oxygen sensor, as long as at least one of the oxygen sensors is usable.

The limiting oxygen concentration can be ascertained on the basis of a mixture diagram and/or a calibration function.

The mixture diagram is in particular the ternary mixture diagram of the components combustible gas, air, and inert gas. Such mixture diagrams are known for many combustible gases and inert gases or can be created in a simple manner.

The oxygen concentration is proportional to the component of air in the housing of the electrical stored energy source, so that converting the measured value obtained from the oxygen sensor into an air content is possible in a simple manner.

The threshold value is preferably at least 0.5 times the limiting oxygen concentration, preferably at least 0.9 times the limiting oxygen concentration, particularly preferably at least 0.95 times the limiting oxygen concentration.

In one variant, the threshold value is in the range of 0.5 times to 0.95 times the limiting oxygen concentration.

In other words, the threshold value according to the invention is at most equal to the limiting oxygen concentration, but at the same time it is preferably an oxygen concentration which is only slightly below the limiting oxygen concentration. In this way, it can be ensured that as little inert gas as possible is consumed, while a reliable operation of the electrical stored energy source still remains ensured, optionally with a small safety amount as a buffer below the limiting oxygen concentration to compensate for unavoidable measuring and/or metering inaccuracies.

In a further variant, the malfunction is established by means of a storage monitoring system of the electrical stored energy source.

The storage monitoring system is in particular a so-called battery management system (“BMS”), which additionally assumes further functions for operating the electrical stored energy source. Therefore, no additional component is necessary for establishing the malfunction.

In particular, it is possible to locate a faulty storage cell within the electrical stored energy source by means of the storage monitoring system.

The storage monitoring system can be connected to the at least one storage cell for data exchange, so that the at least one storage cell can send a warning signal to the storage monitoring system upon occurrence of a malfunction. The storage monitoring system can establish the malfunction of the at least one storage cell based on the warning signal.

The storage monitoring system can have further sensors and/or can be connected to further sensors, which can establish the malfunction of the at least one storage cell and/or the electrical stored energy source, for example via a temperature sensor and/or an impedance sensor.

The storage monitoring system is in particular connected to the metering device for data exchange in order to send a warning message thereto and/or to control the metering device, in particular the valve of the metering device, as soon as a malfunction of the at least one storage cell has been established.

Malfunctions to be expected of the at least one storage cell and/or the electrical stored energy source, which can result in the formation of a combustible gas-air mixture within the housing, are, for example, short-circuits, exceeding a critical temperature, a deformation of at least one storage cell, and/or mechanical damage of at least one storage cell.

The inert gas can be metered into the housing by means of a pipeline of the metering device, in particular via a metering opening of the pipeline, where the pipeline extends at least partially into the interior of the housing.

The point within the housing at which the inert gas flows out can be defined via the size and the positioning of the pipeline.

If the pipeline includes multiple metering openings, each of the metering openings can optionally be operable independently of one another, so that metering of the inert gas in the housing which is even more finely spatially resolved becomes possible.

For example, the inert gas is metered via the metering opening or the metering openings which are spatially closest to a faulty storage cell, in order to reach the limiting oxygen concentration as quickly as possible in the surroundings of the faulty storage cell. Overall, however, in this case inert gas is also metered in a sufficient amount until the threshold value is reached, i.e., an oxygen concentration is reached in the entire empty volume of the housing which is equal to or less than the limiting oxygen concentration.

In one variant, the pipeline is a flexible pipeline, for example made of a plastic. In this way, the pipeline can move or can be moved within the housing, in particular by the inert gas flowing out of the pipeline, by which even faster distribution of the inert gas in the housing can be achieved.

The pipeline can furthermore include at least one weakening zone, which creates the metering opening of the pipeline when a threshold temperature is reached within the housing, for example, by at least partial melting of the pipeline.

The threshold temperature corresponds in particular to a temperature as is reached due to the heat development to be expected upon the occurrence of a malfunction of the at least one storage cell and/or the electrical stored energy source. The threshold temperature is thus reached fastest in the surroundings of a faulty storage cell, so that the metering opening for the inert gas is created in situ in the vicinity of the faulty storage cell, by which the limiting oxygen concentration can be reached particularly quickly close to the faulty storage cell.

In particular, the threshold value is above a permissible operating temperature and/or storage temperature of the at least one storage cell.

The threshold temperature can be in the range of 60 to 90° C.

The metering device comprises in particular a storage container, from which the inert gas is metered into the housing of the electrical stored energy source. Since the method according to the invention only requires enough inert gas to reach the threshold value, the storage container can be designed smaller in comparison to known systems which flood the housing with inert gas, so that the required installation space is reduced according to the invention.

For example, the storage container has a volume in the range of 0.1 to 2.0 L, preferably 0.1 to 0.5 L, particularly preferably 0.1 L.

Due to the lower consumption of inert gas in the method according to the invention, the volume of the storage container can in particular be selected as up to 50% smaller than is possible in the methods known in the prior art.

The resulting reduction of the amount of inert gas to be kept ready reduces both the costs of the method according to the invention and the environmental stress caused by producing and/or releasing the inert gas.

To enable a further reduction of the volume of the storage container, the inert gas can be generated by reacting a precursor upon establishing a malfunction of the at least one storage cell and/or the electrical stored energy source.

The precursor is in particular selected from the group consisting of NH₄HCO₃, NaHCO₃·x H₂O (x=0-10), KHCO₃, (NH₄)₂CO₃·x H₂O (x=0-1), urea, ammonium carbamate, alkaline and alkaline earth salts of oxalic acid, (NH₄)₂C₂O₄·x H₂O (x=0-1), transition metal carbonates, lithium bis(oxalato)borate, C₆(CO₂)₆Cu₃·x H₂O (x=0, 5), and combinations thereof.

Suitable transition metal carbonates are selected in particular from the carbonates of manganese, iron, cobalt, nickel, copper, zinc, and combinations thereof. One preferred transition metal carbonate is nano-zinc carbonate.

Lithium bis(oxalato)borate converts approximately 55% of its weight at approximately 300° C. with formation of gaseous reaction products by the following reaction:

2LiBC₄O₈(s)->Li₂C₂O₄(s)+B₂O₃(s)+3CO(g)+3CO₂(g).

C₆(CO₂)₆Cu₃ designates the copper salt of mellitic acid, which can be used in hydrate water-containing (C₆(CO₂)₆Cu₃·5 H₂O) or hydrate water-free (C₆(CO₂)₆Cu₃) form.

Upon heating to 200 to 260° C., hydrate water-containing copper (II)-mellitate decomposes into H₂O, CO₂, and a mixture of copper, copper (I) oxide, and carbon. The copper component is used to oxidize the CO forming upon the decomposition to CO₂, as described, for example, in Thermochimica Acta, Vol. 239 (1994), pages 211-224. The release of the hydrate water is endothermic and withdraws heat from the surroundings. The weight efficiency is 53.8 wt. %, i.e., 53.8 wt. % of the hydrate water-containing copper (II)-mellitate used is converted into gaseous products.

Water-free copper (II)-mellitate has the advantage that less energy, for example electrical energy, has to be applied to achieve a reaction of the precursor than is the case for hydrate water-containing copper (II)-mellitate.

In a further variant, the housing is divided by means of a gas-impermeable partition plate into a first chamber and a second chamber, wherein the oxygen concentration is ascertained by means of the oxygen sensor within the second chamber. In this variant, the at least one storage cell comprises a storage cell housing, which is arranged on or at the partition plate in the first chamber and which includes a housing opening, wherein the housing opening is closed by means of a safety mechanism and aligns with a feedthrough of the partition plate to the second chamber. In this variant, the safety mechanism opens the storage cell housing upon a malfunction of the at least one storage cell and/or the electrical stored energy source.

The safety mechanism is preferably a bursting membrane, which opens upon reaching a predetermined pressure within the storage cell housing.

In this variant, it is only necessary for the threshold value to be reached in the second chamber of the housing, since combustible gases escaping from the faulty storage cell can only flow into the second chamber. In this way, the amount of inert gas required to reach the threshold value can be further reduced. To further amplify this effect, the volume of the second chamber is particularly preferably smaller than the volume of the first chamber.

If the metering device has a pipeline, it is arranged in the second chamber in this variant.

To prevent additional openings from forming at other points of the storage cell housing in the event of a malfunction of the at least one storage cell, at which the safety mechanism is not arranged, the storage cell housing is in particular made of stainless steel or aluminum. Such a storage cell housing can also withstand high temperatures and pressures within the storage cell.

The feedthrough can be arranged in a cooling area of the partition plate, in which at least one inlet for a coolant is arranged, which is blocked up to the triggering of the safety mechanism. Such partition plates are known, for example, from DE 10 2017 212 223 A1. This enables cooling of combustible gases escaping from the faulty storage cell.

The object of the invention is furthermore achieved by an electrical stored energy source having a housing and at least one storage cell arranged inside the housing, an oxygen sensor which is configured to ascertain the oxygen content within the housing, and a metering device, wherein the metering device is configured to meter inert gas into the housing, and wherein the electrical stored energy source is configured to carry out the above-described method.

Further advantages and properties of the invention result from the following description of selected embodiments, which are not to be understood in a restricted meaning, and from the drawings.

### BRIEF DESCRIPTION OF THE DRAWINGS

FIG. 1 schematically shows a first embodiment of the electrical stored energy source according to the invention;

FIG. 2 is a block diagram of the method according to the invention for operating the electrical stored energy source from FIG. 1;

FIG. 3 is a ternary mixture diagram of combustible gas-air-inert gas, as is used in the method according to the invention from FIG. 2; and

FIG. 4 schematically shows a second embodiment of the electrical stored energy source according to the invention.

### BRIEF DESCRIPTION OF THE DRAWINGS

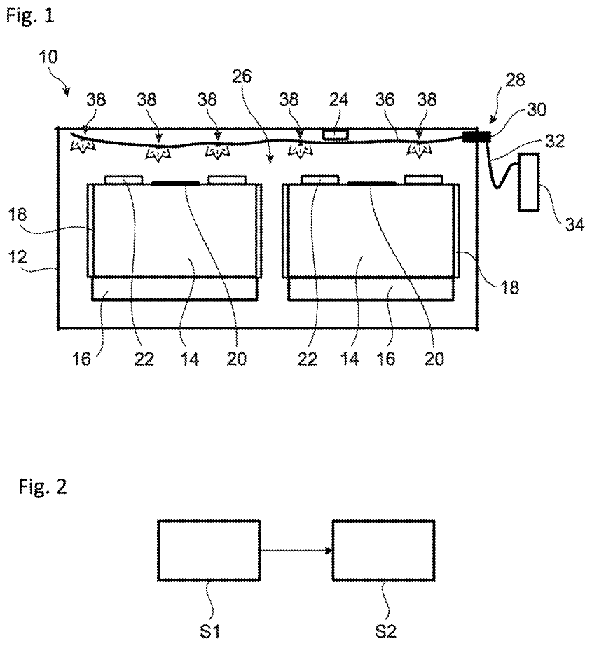

FIG. 1 schematically shows a first embodiment of an electrical stored energy source 10 according to the invention.

The electrical stored energy source 10 comprises a housing 12 and multiple storage cells 14, which are arranged on cooling plates 16 inside the housing 12.

Only two storage cells 14 are shown in FIG. 1. However, the electrical stored energy source 10 can also in principle only comprise a single storage cell 14 or more than two storage cells 14.

The storage cells 14 each have a storage cell housing 18, which is made in particular of stainless steel or aluminum.

Furthermore, a safety mechanism 20 is provided on each of the storage cells 14, which is a bursting membrane in the embodiment shown which opens itself and thus the storage cell housing 18 upon reaching a predetermined pressure within the respective storage cell housing 18.

The storage cells 14 moreover have contacts 22 for electrical contacting.

In the embodiment shown, the storage cells 14 are prismatic cells. In principle, however, other structural forms can also be used for storage cells 14, for example, cylindrical cells or pouch cells.

The storage cells 14 are lithium-ion cells and the electrical stored energy source 10 is accordingly a secondary lithium-ion battery.

An oxygen sensor 24 is arranged on the inside of the housing 12, which is configured to ascertain the oxygen content within the housing 12, i.e., the oxygen content within an empty volume 26 of the housing 12, wherein the empty volume 26 is filled with air.

Furthermore, the electrical stored energy source 10 has a metering device 28.

The metering device 28 has a valve 30, which is fluidically connected via a supply line 32 to a storage container 34, in which inert gas is stored, in particular in liquefied form.

The metering device 28 furthermore has a pipeline 36, which is fluidically connected to the valve 30 and extends into the interior of the housing 12.

The pipeline 36 is a flexible pipeline made of plastic and has a plurality of metering openings 38.

In principle, the pipeline 36 could also be rigid, for example a metal pipe. Furthermore, only one single or a number of metering openings 38 deviating from FIG. 1 could also be provided.

The oxygen sensor 24 and the metering device 28 are connected to one another for data exchange. In particular, the valve 30 is controllable by means of an electrical regulating signal of the oxygen sensor 24.

Furthermore, it is possible that the oxygen sensor 24 and the metering device 28 are connected to a storage monitoring system (not shown) of the electrical stored energy source 10 for data exchange. In this case, the oxygen sensor 24 sends its measurement data in particular to the storage monitoring system, which is configured to control the valve 30.

The electrical stored energy source 10 is in particular a traction battery in a vehicle (not shown).

A method according to the invention for operating the electrical stored energy source 10 is described hereinafter.

If a malfunction of at least one of the storage cells 14 and/or the electrical stored energy source 10 occurs, a combustible gas-air mixture can form within the housing 12, i.e., within the empty volume 26.

Such a malfunction can be, for example, a short-circuit and/or mechanical damage of at least one of the storage cells 14, which results in a thermal event, in which components of the faulty storage cell 14 decompose, for example, an electrolyte, the active materials, and/or additives of the faulty storage cell 14.

In particular, a pressure increase within the faulty storage cell 14 can result in the opening of the safety mechanism 20, due to which combustible gases flow out of the associated storage cell housing 18 while forming the combustible gas-air mixture in the empty volume 26.

The malfunction is firstly established by the electrical stored energy source 10 (step S1 in FIG. 2).

The malfunction can be established via the storage monitoring system (not shown).

Furthermore, it is possible that a change of the measurement data acquired by the oxygen sensor 24 is used to establish a malfunction. For example, a malfunction is assumed if the measurement data of the oxygen sensor 24 change more strongly and/or faster than defined via a warning threshold stored in the oxygen sensor 24 and/or in the storage monitoring system.

Subsequently, inert gas is metered by means of the metering device 28 from the storage container 34 via the valve 30, the pipeline 36, and the metering openings 38 into the interior of the housing 12 (cf. step S2 in FIG. 2), as schematically indicated by arrows in FIG. 1.

Inert gas is supplied to the housing 12 until the oxygen concentration ascertained by the oxygen sensor 24 assumes a threshold value, wherein the threshold value is stored in the oxygen sensor 24 and/or in the storage monitoring system.

The threshold value is equal to or less than the limiting oxygen concentration, which is defined as the lowermost oxygen concentration at which no combustion of the mixture made up of combustible gas, air, and inert gas is possible in the electrical stored energy source 10.

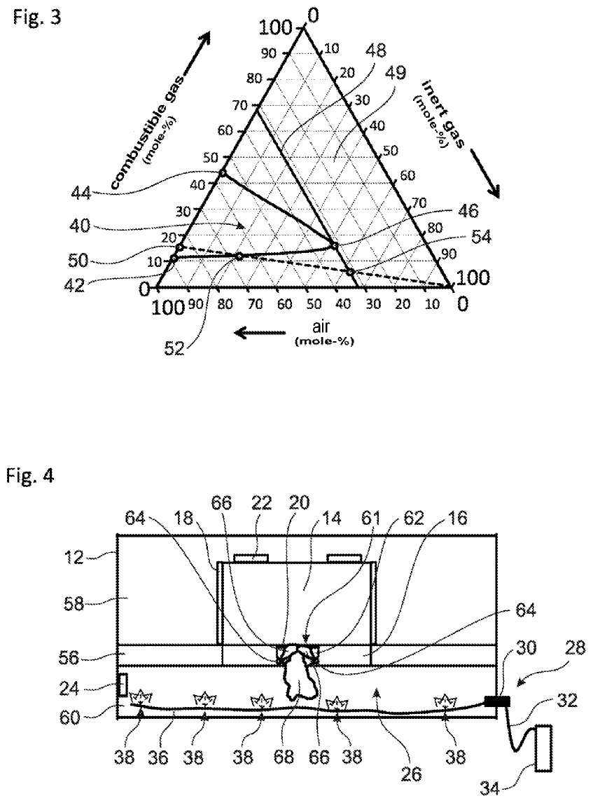

The limiting oxygen concentration can be ascertained on the basis of a mixture diagram, as is shown by way of example in FIG. 3.

The ternary mixture diagram shown in FIG. 3 describes the behavior of an exemplary mixture made of combustible gas, air, and inert gas.

Explosive mixtures made up of combustible gas, air, and inert gas are only present within an explosion range 40. The explosion range 40 is delimited by the lower explosion limit at a first point 42, the upper explosion limit at a second point 44, and the limiting oxygen concentration at a third point 46.

The lower explosion limit and the upper explosion limit are characteristic values of a binary mixture which only contains the combustible gas and air. The delimitation of the explosion range 40 is induced in this binary mixture system by a deficiency of combustible gas or by a deficiency of oxidant, i.e., by a deficiency of oxygen contained in the air.

The limiting oxygen concentration corresponds to the oxygen concentration in a ternary gas mixture made up of combustible gas, air, and inert gas, below which no explosive mixtures can exist, independently of the existing amount of combustible gas and air, as illustrated in FIG. 3 with the aid of the line 48.

Accordingly, more reliable operation of the electrical stored energy source is possible if the composition of the mixture made up of combustible gas, air, and inert gas is in a range 49 of the mixture diagram.

The effect of the method according to the invention is explained in more detail hereinafter on the basis of the mixture diagram from FIG. 3.

It is apparent from the mixture diagram from FIG. 3 that in the example shown below an air component of 32 mole-% (corresponding to 6.688 mole-% oxygen) explosive mixtures cannot occur.

The air component can be calculated from the oxygen concentration as is ascertained via the oxygen sensor 24 (cf. FIG. 1), in particular via the oxygen partial pressure.

If a malfunction of at least one storage cell 14 or the electrical stored energy source 10 now occurs, upon which a combustible gas-air mixture forms within the housing 12, this mixture can have a composition within the explosion range 40, as indicated by way of example in FIG. 3 as a fourth point 50.

To move out of the explosion range 40, starting from the fourth point 50, a feed of inert gas into the housing would be necessary, which results in a composition according to a fifth point 52. In the mixture diagram shown in FIG. 3, this corresponds to a content of 21 mole-% inert gas.

The precise location of the fourth point 50, however, is unknown during operation of the electrical stored energy source 10, so that potentially explosive mixtures could still be present at a content of 21 mole-% inert gas.

According to the invention, inert gas is therefore metered into the housing 12 until the oxygen concentration assumes the threshold value, which is less than or equal to the limiting oxygen concentration.

In this way, independently of the original composition of the combustible gas-air mixture, a gas composition is achieved within the housing 12, which lies at least on the line 48 and therefore outside the explosion range 40.

In the mixture diagram shown in FIG. 3, this corresponds to a composition at a sixth point 54 of 32 mole-% air (corresponding to 6.688 mole-% oxygen), 6 mole-% combustible gas, and 62 mole-% inert gas.

Therefore, a more reliable operation of the electrical stored energy source 10 with minimized consumption of inert gas is enabled in the method according to the invention solely based on the measurement of the oxygen concentration.

FIG. 4 shows a second embodiment of the stored energy source 10 according to the invention.

The second embodiment essentially corresponds to the first embodiment, so that only differences will be discussed hereinafter. Identical components are provided with identical reference signs and reference is made to the above statements.

In the second embodiment, the housing 12 is divided by means of a gas-impermeable partition plate 56 into a first chamber 58 and a second chamber 60.

The cooling plate 16 is part of the partition plate 56 in this embodiment.

The storage cell 14 is arranged within the first chamber 58 on the partition plate 56, more precisely on the cooling plate 16 of the partition plate 56.

The safety mechanism 20 is arranged with a lower side of the storage cell housing 18 on the partition plate 56 and closes an opening (not shown in more detail) of the storage cell 14, wherein the opening aligns with a feedthrough 61 of the partition plate 56, more precisely with a feedthrough 61 in the cooling plate 16 of the partition plate 56.

The feedthrough 61 is arranged in a cooling area 62 of the cooling plate 16, which comprises two inlets 64 for a coolant 66.

A state is shown in FIG. 4 in which the storage cell 14 already has a malfunction which resulted in the opening of the safety mechanism 20. Therefore, combustible gas 68 flows out of the opening of the storage cell housing and through the feedthrough 61 of the partition plate into the second chamber 60.

The escaping combustible gas 68 and the storage cell 14 are cooled by the coolant 66, which is sprayed via the inlets 64 into the cooling area 62.

At the same time, inert gas is metered via the metering openings 38 of the pipeline 36 into the second chamber 58, as indicated by arrows, analogously to the above statements on the first embodiment of the electrical stored energy source 10.

However, in the second embodiment, the threshold value only has to be reached in the second chamber 58, since combustible gas is only present in the second chamber 58, so that the required amount of inert gas is reduced further.

1.-10. (canceled)

11. A method for operating an electrical stored energy source, wherein the electrical stored energy source comprises a housing and at least one storage cell arranged inside the housing, the method comprising:
determining a malfunction of the at least one storage cell and/or the electrical stored energy source, in which a combustible gas-air mixture is formed within the housing; and
metering an inert gas into the housing by way of a metering device of the electrical stored energy source, wherein enough inert gas is metered into the housing that the oxygen concentration inside the housing assumes a threshold value,
wherein the oxygen concentration is ascertained by way of an oxygen sensor of the electrical stored energy source, and
wherein the threshold value is equal to or less than a limiting oxygen concentration, which is defined as a lowermost oxygen concentration at which no combustion of the mixture made up of combustible gas, air, and inert gas is possible in the electrical stored energy source.

12. The method according to claim 11, wherein
the limiting oxygen concentration is ascertained based on a mixture diagram and/or a calibration function.

13. The method according to claim 11, wherein
the threshold value is at least 0.5 times the limiting oxygen concentration.

14. The method according to claim 11, wherein
the threshold value is at least 0.9 times the limiting oxygen concentration.

15. The method according to claim 11, wherein
the threshold value is at least 0.95 times the limiting oxygen concentration.

16. The method according to claim 11, wherein
the malfunction is determined by use of a storage monitoring system of the electrical stored energy source.

17. The method according to claim 11, wherein
the inert gas is metered into the housing via a pipeline of the metering device, wherein the pipeline extends at least partially into the interior of the housing.

18. The method according to claim 17, wherein
the pipeline is a flexible pipeline.

19. The method according to claim 17, wherein
the pipeline includes at least one weakening zone, which creates a metering opening of the pipeline when a threshold temperature is reached within the housing.

20. The method according to claim 11, wherein
the metering device comprises a storage container from which the inert gas is metered into the housing, and
the inert gas is created by reacting a precursor upon establishing the malfunction of the at least one storage cell and/or the electrical stored energy source.

21. The method according to claim 11, wherein
the housing is divided by way of a gas-impermeable partition plate into a first chamber and a second chamber,
the oxygen concentration is ascertained by way of the oxygen sensor inside the second chamber,
the at least one storage cell comprises a storage cell housing, which is arranged on or at the partition plate in the first chamber, and the storage cell housing includes a housing opening,
the housing opening is closed by a safety mechanism and the housing opening aligns with a feedthrough of the partition plate to the second chamber, and
the safety mechanism opens the storage cell housing in an event of the malfunction of the at least one storage cell and/or the electrical stored energy source.

22. An electrical stored energy source, comprising:
a housing;
at least one storage cell arranged inside the housing;
an oxygen sensor configured to ascertain an oxygen concentration inside the housing; and
a metering device configured to meter inert gas into the housing,
wherein the electrical stored energy source is configured to:
determine a malfunction of the at least one storage cell and/or the electrical stored energy source, in which a combustible gas-air mixture is formed within the housing; and
meter, via the metering device, the inert gas into the housing, wherein enough inert gas is metered into the housing that the oxygen concentration inside the housing assumes a threshold value,
wherein the threshold value is equal to or less than a limiting oxygen concentration, which is defined as a lowermost oxygen concentration at which no combustion of the mixture made up of combustible gas, air, and inert gas is possible in the electrical stored energy source.
